(19) United States
(12) Patent Application Publication
(10) Pub. No.: US 2015/0068974 A1
(43) Pub. Date: Mar. 12, 2015

(54) IN-SITU AEROGELS AND METHODS OF MAKING SAME

(71) Applicant: The Massachusetts Institute Technology, Cambridge, MA (US)

(72) Inventors: Jing Kong, Winchester, MA (US); Sung Mi Jung, Malden, MA (US)

(73) Assignee: The Massachusetts Institute Technology, Cambridge, MA (US)

(21) Appl. No.: 14/019,952

(22) Filed: Sep. 6, 2013

(51) Int. Cl. C09K 3/00; B01D 53/14; C09K 3/32; B01D 15/08; C01G 23/053; C01D 1/02

(52) U.S. Cl. CPC C09K 3/00; C01G 23/053; C01D 1/02; C09K 3/32; B01D 15/08; B01D 53/14; B01D 53/1487
USPC 210/502.1; 210/635; 95/90; 95/141; 95/143; 96/153; 423/210; 516/98

(57) ABSTRACT

Provided in one embodiment is a method of making an aerogel, comprising: (A) subjecting a suspension or a solution comprising a concentration of at least one chemical reactant to at least one of a hydrothermal and a solvothermal process for at least a reaction time to form an in-situ hydrogel, wherein the hydrogel comprises particulates having an asymmetric geometry, and (B) removing a liquid from the hydrogel to form an aerogel.

### STATEMENT REGARDING FEDERALLY SPONSORED RESEARCH

This invention was made with government support under DMR 0845358, awarded by the National Science Foundation (NSF). The United States government has certain rights in this invention.

### BACKGROUND

Aerogels have various applications due to their high surface area and low densities. However, creating various material aerogels has remained a challenge. For example, to date there are only limited types of materials that can be made into “aerogel” structures. These include metal oxide aerogels (e.g., SiO₂, Al₂O₃), carbon material aerogels (such as carbon, carbon nanotubes (CNTs), graphene), and more recently semiconducting chalcogenide aerogels (e.g., CdS, CdSe, PbTe).

One reason that the type of usable materials to form aerogels is limited is the challenge of forming the starting “gel.” Most aerogels are obtained through a sol-gel process with a suitable gelling agent precursor. For example, in the case of SiO₂ aerogel, a liquid alcohol (e.g., ethanol) is mixed with a silicon alkoxide precursor, (e.g. tetramethyl orthosilicate (TMOS) or tetraethyl orthosilicate (TEOS)). A hydrolysis reaction forms particles of silicon dioxide, which may form a sol solution. The oxide suspension then undergoes condensation reactions, which result in the creation of metal oxide bridges (M-O-M bridges or M-OH-M bridges) linking the dispersed colloidal particles. When this interlinking has stopped the flow of liquid within the material, a gel is made. Carbon aerogels are made by subjecting gel precursor to supercritical drying and subsequent pyrolysis of an RF aerogel at high temperature. Because this cross-linking reaction is specific only to a selected group of materials, the number of materials that may be used to form aerogels is limited.

### SUMMARY

In view of the foregoing, the Inventors have recognized and appreciated the advantages of methods of enabling aerogel fabrication with a wide variety of materials.

Provided in one aspect of the invention is a method of making, comprising: (A) subjecting a suspension or a solution comprising a concentration of at least one chemical reactant to at least one of a hydrothermal and a solvothermal process for at least a reaction time to form an in-situ hydrogel, wherein the hydrogel comprises particulates having an asymmetric geometry; and (B) removing a liquid from the hydrogel to form an aerogel.

Provided in another aspect of the invention is a method of using, comprising: (A) exposing a composition to a fluid comprising a component to be removed; and (B) removing the component from the fluid by retaining a portion of the fluid in the composition such that at least some of the component in the fluid is retained in the composition. The composition may comprise a hydrogel or an aerogel, which comprises particulates having an asymmetric geometry.

Provided in another aspect is a composition, comprising: an aerogel, which comprises particulates having an aspect ratio of at least 50 and comprising at least one metal oxide; and having a density of less than or equal to about 16 mg/cm³.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The patent or application file contains at least one drawing executed in color. Copies of this patent or patent application publication with color drawings will be provided by the Office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1(a)-1(g) illustrate fabrication of cryptomelane-type manganese oxide nanowire hydrogel/aerogel in one embodiment: (a) shows an inorganic nanowire hydrogel/aerogel production process; (b) shows 3D network structures of cryptomelane-type manganese oxide (K₂₋xMn₈O₁₆) nanowire aerogel from suspension C at 48 h; (c) shows densities of the nanowire aerogels vs. concentration of the initial reactant suspension (A: precursor suspensions without any treatment; B: filtration of A with a 0.8 μm syringe filter; C: two-fold dilutions of B; D: three-fold dilutions of the suspension after filtration of A with a 0.2 μm syringe filter); (d) densities of the nanowire aerogels vs. reaction times for suspension B; (e)-(g) show 3D network structures of the nanowire aerogel from suspension B at 5, 45, and 96 h.

FIGS. 2(a)-2(d) show mechanical properties of cryptomelane nanowire aerogels in one embodiment: (a) and (b) show the aerogels with flexible, bendable and super-elastic properties; (c) shows the result of a tensile test for the aerogels with different densities of 16 (for 96 h at concentration B), 10 (5 h or 45 h at B), and 4 mg/cm³ (48 h at C); (d) shows the result of a compressive test for the aerogels with different densities of 16 (for 96 h at B), 10 mg/cm³ (5 h or 45 h at B) and 4 mg/cm³ (48 h at C).

FIGS. 3(a)-3(g) show cryptomelane nanowire aerogels as oil/solvent absorbents in one embodiment: (a) and (b) provide optical images for hydrophobic cryptomelane nanowire aerogels after surface treatment, as evident of a water contact angle of 148° with a 13.3 μL water droplet; (c)-(f) illustrates the process of motor oil absorption of 10 mg/cm³ cryptomelane nanowire aerogel, which shows the selective absorption of the blue color of stained motor oil floating on DI water within 41 s; (g) shows weight-to-weight absorption capacities (W (wt/wt)) for different kind of solvents/oils with the aerogels having densities of 4, 10 (45 h), and 16 mg/cm³.

FIGS. 4(a)-4(d) show water purification filters of the cryptomelane nanowire hydrogel for the removal of organic dye and toxic heavy metal ions in one embodiment: (a) shows UV-vis-NIR spectrum before and after filtration of 0.1 wt % MB methylene blue (MB) with the cryptomelane nanowire hydrogel filter inserted in syringe holder (optical image of inset); (b) shows the performance of cryptomelane nanowire hydrogels as water filters for the removal of heavy metal ions: 1000 ppm Pb²⁺, 1000 ppm Cd²⁺, 100 ppm Cr₂O₇²⁻, or 100 ppm Cu²⁺, which the highest uptake of Pb²⁺, Cd²⁺, Cr₂O₇²⁻, or Cu²⁺ is 100, 91, 95, or 88.3% and saturated at 78, 70, 75, 59%, respectively; (c) shows the maximum uptake capabilities for the heavy metal ions which is determined to be Pb²⁺>Cd²⁺>Cr₂O₇²⁻>Cu²⁺; (d) shows the absorption test using different absorbent dosages of 0.02, 0.04, 0.06, 0.08, and 0.1 g MnO₂ nanowire hydrogels which shows high removal % of 47, 87.8, 100, 100, and 100%, respectively—the maximum uptake capability for the absorption is 0.6 g/g.

FIGS. 5(a)-5(b) illustrate 3D network structures of cryptomelane nanowire aerogels in one embodiment: (a) shows the nanowire aerogel from three-fold dilutions of suspension filtered with a 0.2 μm syringe filter; and (b) shows the nanowire aerogel from non-treated suspension. The densities of the nanowire aerogels are 2.9 and 51 mg/cm³, respectively.

FIGS. 6(a)-6(b) show SEM images of in-situ TiO₂ nanowires aerogels in one embodiment: (a) and (b) show TiO₂ nanowire aerogels with 5-10 nm and 50-60 nm diameter, respectively. These images show highly porous and ultrafine nanowires networks with pore sizes in the range of a few hundred nanometers to a few micrometers.

FIGS. 7(a)-7(c) show 3D network structures of TiO₂ nanowire aerogels from different reaction times of 4 (a), 16 (b), and 48 h (c), respectively, in one embodiment.

FIGS. 8(a)-8(h) illustrate characterization of structures of cryptomelane (K₂₋xMn₈O₁₆) and TiO₂ nanowire aerogels in one embodiment: (a-b) and (c-d) show TEM images of cryptomelane and TiO₂ nanowire—TiO₂ nanowires synthesized from KOH have 10-15 nm diameter; (e) and (f) show XRD diffraction for cryptomelane and TiO₂ nanowire aerogels. (g) and (h) are N₂ adsorption and desorption isotherms for cryptomelane and TiO₂ nanowire aerogels. The ultra-fine porous cryptomelane and TiO₂ nanowire networks result in high surface areas of 80 m²g⁻¹ and 292 m²g⁻¹, respectively.

FIGS. 9(a)-9(d) illustrate the fabrication of cryptomelane and TiO₂ aerogels in one embodiment: (a) shows a schematic diagram of the manufacturing process of the cryptomelane and TiO₂ nanowire aerogels—the aerogels form in-situ in one step through a hydrothermal synthesis process; CPD stands for critical point drying; (b)-(d) show SEM images of the MnO₂ and TiO₂ aerogels.

### DETAILED DESCRIPTION

Following are more detailed descriptions of various concepts related to, and embodiments of, inventive aerogels and methods of making same. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

In one aspect, a method of making a composition comprising an aerogel is provided. The method may include first subjecting a suspension or a solution comprising a concentration of at least one chemical reactant to at least one of a hydrothermal and a solvothermal process for at least a reaction time to form an in-situ hydrogel, wherein the hydrogel comprises particulates having an asymmetric geometry. Subsequently, the liquid in the gel may be removed such that an aerogel is formed. In some embodiments provided herein, the gel and the aerogel may have substantially the same geometry.

A suspension in some embodiments may refer to a two phase mixture—e.g., a chemical reactant in the form of nanoparticles suspended in a fluid solvent. For example, the suspension may be in a colloidal form. On the other hand, a solution in some embodiments may refer to a relatively uniform and/or homogenous one phase mixture. For example, the solution may be a fluid containing dissolved ions. In some instances, when the suspension is very diluted (e.g., to the point where the precipitates or chemical reactant is almost not visible), the suspension may be considered a solution.

Gels (hydrogels or aerogels) may contain a solid three-dimensional network of particulates that generally spans the volume of a liquid medium and ensnares it through surface tension effects. The bonding between the branches of the 3-D network could be either physical (e.g., van der Waals forces) or chemical (e.g., covalent) bonds. This internal network structure may result from physical bonds or chemical bonds, as well as crystallites or other junctions that remain intact within the extending fluid. For example, hair gels contain mainly positively charged polymers—i.e., cationic polymers. Their positive charges may prevent the formation of coiled polymers. The positive charges allow the polymers to contribute more to viscosity in their stretched state because the stretched-out polymer takes up more space than a coiled polymer, thereby resisting the flow of solvent molecules around the polymer molecule.

In one embodiment, when the concentrations of particulates suspended in a solvent in a gel precursor (e.g., water in a case of hydrothermal synthesis or an organic solvent in the case of solvothermal synthesis) reaches a certain level, the flow of solvent may be stopped and a gel may form as a result. This level is sometimes referred to as a gel transition point. Therefore, when the concentration of a suspension of long chain molecules, or colloidal particulates of a certain geometry becomes high enough, the probability of these particulates interlinking with one another also becomes high. When this happens, a gel may be made. Once a gel is formed, an aerogel material may be fabricated from the gel by extracting the solvent liquid from the gel.

An embodiment of aerogel and the formation thereof is provided in patent application U.S. Ser. No. 13/757,415 to Jung et al. It is noted that while Ser. No. 13/757,415 provides descriptions of aerogels and aerogel formation, the aerogels and the methods of making and using same provided herein are distinguishable from those described in Ser. No. 13/757,415, as will be demonstrated below. For example, in contrast to the fabrication as described in Ser. No. 13/757,415, the fabrication method described herein allows in-situ hydrogel and aerogel to be formed using, for example, a hydrothermal and/or a solvothermal process. It is noted that in at least some embodiments herein, the term hydrogel may encompass more than gels formed using a water-based reaction—e.g., it may encompass those formed by a solvothermal process as well. In other words, in at least one embodiment, the formation of the in-situ hydrogel may comprise a one step process. In another embodiment, the formation of the in-situ aerogel comprises a one step process: an example may involve, for example, leaving a hydrogel in the ambient condition to dry to form an aerogel without subjecting the hydrogel to any particular drying process. Surprisingly, the differences in fabrication methods could have contributed to the improvement in several material properties of the aerogels described herein, in comparison to those provided in Ser. No. 13/757,415. Furthermore, due at least in part to the improvement in material properties, the aerogels provided herein may be used in a wider array of applications than those described in Ser. No. 13/757,415.

### Gel

The term gels herein may refer to hydrogel, which as described above may encompass a gel formed by a fluid-based process (e.g., hydrothermal and/or solvothermal). In one embodiment, at least one chemical reactant in a solvent, be it water or any other type of solvent, is adapted to form a network of particulates forming a gel (e.g., a hydrogel). The chemical reactant(s) in the solvent may be in the form of a suspension or a solution. The chemical reactant may share at least one chemical element in common with the particulates. The term element may refer to any of the elements found in a Periodic Table.

The particulates described herein may comprise, or be, any material, depending on the type of aerogel desired. The methods described herein are versatile and may be employed to make any type of aerogel material. For example, the particulates may contain a metal, a compound, a semiconductor, a carbon-containing material, or combinations thereof. One surprising feature of at least one embodiment described herein is that the methods described herein allow gel (and finally aerogel) to be formed with a relative low concentration of the precursor material.

The metal may be any metal, including noble metals and transition metals. For example, a noble metal may be gold, silver, platinum, copper, and the like. A transition metal may be any element in Groups 3-12 of the Periodic Table. The term “element” herein refers to the elements found on the Periodic Table. For example, a transition metal may be Sc, Y, Ti, Zr, Hf, Rf, V, Nb, Ta, Db, Cr, Mo, W, Sg, M, Tc, Re, Bg, Fe, Ru, Os, Hs, Co, Rh, Ir, Mt, Ni, Pd, Pt, Ds, Cu, Ag, Au, Rg, Zn, Cd, Hg, Cn. In some embodiments, the metal may be silver.

The compound may refer to any compound depending on the applications. For example, the compound may be an oxide, a nitride, a chalcogenide, and the like. An oxide may be a metal oxide (e.g., alumina, titania, iron oxide, zinc oxide, manganese oxide, alkali-metal oxide, alkali-earth metal oxide, or any of the metals described above). In one embodiment, the metal oxide may be at least one of manganese dioxide, titanium oxide, zinc oxide, zirconium oxide, copper oxide, and chromium oxide. The oxide may also be a non-metal oxide, including silica. The compound may also be a metal nitride or metal sulfide, including any of the aforementioned metals as the metal element. For example, the compound may be MoS₂, CdS, CdSe, PbTe, or combinations thereof. Alternatively, the nitride and sulfide may be a non-metal nitride and sulfide. For example, the compound may be a boron nitride (e.g., hexagonal boron nitride, or “h-BN”).

The semiconductor may be any known semiconductors. The semiconductor may be an elemental semiconductor (only one element) or a compound semiconductor (more than one element). For example, the semiconductor may be silicon. Alternatively, the material may be GaAs, GaN, MnO₂, TiO₂, ZnO, Bi₂Te₃, or combinations thereof.

The carbon-containing material may be any known structure that contains carbon atoms. For example, the material may be graphite, carbon nanotube, carbon nanowire, or graphene. The carbon nanotubes may be single-walled carbon nanotubes, multi-walled carbon nanotubes, or both.

The particulates described herein may have any geometry and need not be spherical. The particulates described herein may have an asymmetric geometry (e.g., anisotropy) such that one dimension thereof is greater than the other; the dimensions described herein may refer to the diameter, length, width, or height of the particulate. One feature of at least some embodiments described herein is the formation of aerogels using 1-D and/or 2-D materials using general principle of gel formation based on shape asymmetry. For example, the particulates may be wire-like, tube-like (i.e., wire-like but hollow), sheet-like, flake-like, or any other shape. Because of the nanometer length scale, in some embodiments the particulates may be referred to as nanotubes, nanowires, or nanosheets, depending on the geometry; the particulates may comprise any of the aforedescribed materials.

The asymmetry may be described by, for example, an aspect ratio, which in one embodiment herein may refer to a ratio of the length to the diameter of a particulate (for a tubular/wire like configuration) or to a ratio of the width or length to the thickness of a particulate (for a sheet-like configuration). Accordingly, the particulates may have an aspect ratio of greater than about 1—e.g., greater than about 10, about 50, about 100, about 150, about 200, about 250, about 300, about 350, about 400, about 450, about 500, about 550, about 600, about 650, about 700, about 750, about 800, about 850, about 900, about 950, about 1000, about 2000, about 5000, about 10000, or more. The aspect ratio may be higher (towards infinity) or lower (towards 1.1) than the aforedescribed values. For example, the aspect ratio may be between about 1 and about 10000—e.g., about 10 and about 5000, about 100 and about 1000, about 200 and about 500.

The chemical reactant(s) in the suspension may be in a colloidal form. The particulates may have any size, ranging from nanometers to microns. The size may refer to an average size in the case of a plurality of particulates. The size may refer to any dimension, including length, width, height, thickness, diameter, etc., depending on the geometry. In some embodiments, the particulates may comprise fibers (e.g., polymer fibers, glass fibers, etc.) and the diameter of the particulate may be in the micron range. In some other embodiments, the diameter of the particulate described herein may be less than about 500 nm—e.g., less than about 400 nm, about 300 nm, about 200 nm, about 100 nm, about 50 nm, about 20 nm, about 10 nm, about 5 nm, about 1 nm, or less. For example, the diameter may be between about 10 nm and about 500 nm, —e.g., about 20 nm and about 400 nm, about 50 nm and about 300 nm, about 100 nm and about 200 nm.

Another distinguishing feature of the aerogel described from that synthesized by a pre-existing method, including that described in Ser. No. 13/757,415 is the length of the particulates. In at least one embodiment, at least because the hydrogel and/or aerogel is formed herein in-situ without initially dispersing the particulates in the suspension by a technique such as sonication, the particulates of the hydrogels/aerogels herein may retain a much larger length than the hydrogel/aerogel provided in Ser. No. 13/757,415. For example, the length of the particulates herein may be at least about 0.5 microns—e.g., at least about 1 micron, about 10 microns, about 20 microns, about 40 microns, about 60 microns, about 80 microns, about 100 microns or more. In one embodiment, the length may be at least about 100 microns—e.g., at least about 200 microns, about 300 microns, about 400 microns, about 500 microns, about 600 microns, about 700 microns, about 800 microns, about 900 microns, about 1000 microns, or more. In one embodiment, the particulates have a length that is greater than or equal to about 100 microns and have a diameter that is less than or equal to about 500 nm. The particulates in this embodiment may comprise a metal oxide, such as any of those described above.

The suspension or solution may optionally include a surfactant, which may be used to prevent or reduce van der Waals attraction between the chemical reactants (and/or later the particulates formed), particularly those with a small diameter. In some embodiments, surfactants may be used to prevent aggregation of the reactant and/or particulates. For example, in some embodiments, when the diameters of the reactant and/or particulates are less than about 100 nm (e.g., less than about 50 nm, about 20 nm, about 10 nm, about 1 nm, or less) at least one surfactant may be used. The surfactant may comprise at least one of sodium dodecylbenzene sulfonate (SDBS), planar sodium cholate, sodium dodecylsulfate (SDS), sodium deoxycholate (SDC), and polyvinylpyrrolidone (PVP). In some other embodiments, no surfactant is needed and the particulates do not aggregate to one another.

The particulates of the aerogels may be made using chemical vapor deposition (CVD), physical vapor deposition (PVD), hydrothermal, solvothermal, and/or electrochemical deposition in anodic aluminum oxide (AAO) template. In some embodiments, hydrothermal synthesis may refer to a method of crystallizing a substance from hot water under high pressure. The temperature of the water may be at about 50° C. or more—e.g., about 60° C., about 70° C., about 80° C., about 90° C., or more. The pressure may be at least about 2 atm—e.g., about 3 atm, about 4 atm, about 5 atm, or more. Subsequently, gels may be formed from the method described below. In one embodiment, the nanowires synthesis may involve at least one of hydrothermal synthesis of MnO₂ and/or TiO₂, CVD synthesis of ZnO and/or GaN, and electrochemical etching/deposition of Si, Bi₂Te₃, Ag, Pt, and/or Au nanowires.

### Gel Formation

As described above, the gels formed by the methods described herein may be employed to form aerogels. As one example, one difference between the conventional gel precursor and that described herein is that the nanoparticles network of the conventional system is chemically cross-linked by covalent bonding, whereas the nanowire and nanosheet networks of a gel precursor described herein are initially physically bonded by van der Waals forces. In some embodiments, other agents may be used later to enhance the mechanical properties of the gels/aerogels, which may form covalent bonding between the nanowire/nanosheet and the agent.

Further, as already described above, the formation of gel (e.g., hydrogel) described herein differs from that in pre-existing methods, including that described in U.S. application Ser. No. 13/757,415, at least in that the gel described herein forms as an in-situ gel from the precursor as a result of a hydrothermal process. In other words, in at least one example the gel formation may involve chemical reactant in a suspension/solution forming a gel in a one step process without having to first undergo a process of forming the suspension (e.g., by dispersion) and then to form a gel. By contrast, the gel in the pre-existing method, including that described in U.S. application Ser. No. 13/757,415, is not formed in-situ; rather, the precursors (for example, nanowires, nanotubes, or nanosheets) were initially dispersed with/without surfactant in ethanol using ultra-sonication at a dilute concentration, and then the suspension transformed into a gel by evaporating the solvent to reach the gel formation concentration. In at least one embodiment of the pre-existing method where the precursor particulates are brittle, the dispersion process may result in shorter lengths and lower aspect ratios of the particulates. Also, the particulates in at least one embodiment of the aerogels herein are tubular in shape (e.g., wire, tube, etc.) instead of sheets.

The synthesis methods described herein may overcome the aforedescribed challenges faced by the pre-existing methods. For example, the fabrication methods described herein may be employed to obtain porous nanowire hydrogels/aerogels directly from the hydrothermal/solvothermal synthesis. During the hydrothermal/solvothermal process, the gel is synthesized in-situ at an environment with at least controlled pressure and/or temperature for a predetermined period of reaction time. At least one of reaction time, concentration of the chemical reactant, temperature, and pressure involved in the hydrothermal/solvothermal process may be controlled and tailored to affect formation of the hydrogel. In one embodiment, once the concentration of the particulates reaches the gel formation concentration in the precursor suspension after a hydrothermal/solvothermal process, a gel may form in-situ from the chemical reactant(s) inside the hydrothermal vessel. The synthesis method described herein allows the precursor particulates to maintain much longer length (hundreds of micrometers) in networks, which gives rise to much lower density, higher porosity, higher surface area, and desirable mechanical properties for the networks. The process described herein is much simpler and enables large-scale production at much lower costs than the pre-existing methods.

The amount of the pressure and the temperature may be of any suitable amount, depending on the materials and/or process conditions involved. For example, the temperature may be any temperature that is higher than room temperature—e.g., at least about 400 K, about 450 K, about 500 K, about 550 K, about 600 K, about 650 K, about 700 K, about 750 K, about 800 K, about 850 K, about 900 K, about 950 K, about 1000 K, about 1100 K, about 1200 K, about 1300 K, about 1400 K, about 1500 K, about 1600 K, or more. There are no particular upper limits for the temperature other than the capability of the machinery. Other temperature ranges may be possible, depending on the system. The pressure may be any suitable value, depending on the system. For example, the pressure may be at least about 0.5 atm—e.g., at least about 1 atm, about 1.5 atm, about 2.0 atm, about 2.5 atm, or more. In one embodiment, very high pressure may be employed: at least about 10 atm—e.g., at least about 50 atm, about 100 atm, about 200 atm, about 300 atm, about 400 atm, about 500 atm, about 600 atm, about 700 atm, about 800 atm, about 900 atm, about 1000 atm, about 1100 atm, about 1200 atm, about 1300 atm, about 1400 atm, about 1500 atm, about 1600 atm, or more. There are no particular upper limits for the pressure other than the capabilities of the machinery.

The gel formation may be tailored by controlling at least one of the initial concentrations and/or compositions of the chemical reactant(s) in the suspension/solution and a reaction time of the synthesis. Additionally, the temperature, reaction time, and/or pressure may be controlled. The synthesis may involve, for example, hydrothermal or solvothermal synthesis. In one embodiment, the gel may be formed by increasing the concentration of the suspension of a gel precursor to above the gel network transition point, which is described below. The reaction time may be tailored to be of any length of time, depending at least on the materials involved. In general, it is desirable to have the reaction time to be sufficient to allow formation of a network of ultralong particulates at least substantially without agglomeration. For example, the reaction time may be at least about 5 minutes—e.g., at least about 10 minutes, about 20 minutes, about 30 minutes, about 60 minutes, about 2 hours, about 4 hours, about 6 hours, about 8 hours, about 10 hours, about 20 hours, about 30 hours, about 40 hours, about 50 hours, about 60 hours, about 70 hours, about 80 hours, about 90 hours, about 100 hours, about 110 hours, about 120 hours, or longer. In one embodiment, the reaction time is between about 5 h and about 100 h—e.g., about 10 h and about 90, about 20 h and about 890, about 30 h and about 70, about 40 h and about 60, about 45 h and about 55, etc. Other lengths of reaction time are also possible.

Although in at least one embodiment the chemical reactant in suspension or solution is not dispersed during the hydrothermal/solvothermal process, the suspension or solution may be pre-processed before the hydrothermal/solvothermal synthesis process. For example, the suspension or solution may be subjected to at least one of sonication and filtering before the hydrothermal/solvothermal process. The suspension or solution may also undergo dilution before the hydrothermal/solvothermal process. Not to be bound by any theory, but dilution may help ensure that the particulates do not aggregate. The dilution level may be any suitable level, including at least 2 folds—e.g., at least 3, 4, 5, 6, 10, 20, or more.

In the cases where surfactants are used, the surfactants may be removed from the gel before the gel is transformed into an aerogel. In some embodiments, the molded gels may be soaked in water baths to remove the surfactant. The water in the water temperature may be at a second elevated temperature, which may be the same as or different from the aforementioned first elevated temperature. The water may be at, for example, between about 330 K and about 380 K—e.g., at about 333 K, about 353 K, or about 373 K. The soaking may be carried out for any desirable amount of time (e.g., overnight), depending on the type and the amount of the surfactant used. The soaking may be repeated multiple times with fresh water. Subsequently, the gel may be dried to form an aerogel, as described below.

In some embodiments, the methods described herein may further include adding chemical coatings (e.g., polymer electrolyte) directly to the gel (skeleton) before the liquids are extracted from the gel to form aerogels.

### Aerogel Formation

The gel formed according to the methods described above may be further dried to remove the liquid (solvent) from the gel to form an aerogel. The aerogel may contain any of the aforedescribed gels and undergo any of the aforedescribed processes. Drying may be carried out by any suitable drying techniques, depending on the materials involved. The techniques may include (i) freeze drying, (ii) supercritical point drying (“CPD”), (iii) drying in a ambient condition, or combinations thereof. Other drying techniques may also be employed.

In a CPD process in one embodiment, the liquid may be dried off slowly without causing the solid matrix in the gel to collapse from capillary action, as would happen with conventional evaporation techniques. As a result, the 3-D structure of the particulates in the gel may be preserved in the aerogel upon the transition from gel into an aerogel. For example, the aerogel may contain a 3-D network of crystalline nanowires, nanosheets, nanotubes, or combinations thereof. In one embodiment, the particulates in the aerogels herein may be tubular in shape (e.g., wire, tube, etc.) instead of sheets. In some embodiments, the level of preservation may account for minute discrepancies, so long as at least the majority (e.g., substantially all, or even all) of the network structure is preserved. In some embodiments, because of this preservation, the geometry of the gel may also be preserved upon the transition into the aerogel. The geometry in some embodiments herein may refer to shape, size (e.g., volume), and the like.

Because the nanowires may be synthesized by a hydrothermal/solvothermal method, the gel formation may take place during the hydrothermal synthesis when the nanowires are crystallizing out from the hot water under high pressure. In one embodiment, the method may include forming the gel in-situ during the hydrothermal synthesis. In another embodiment, a hybrid mode of synthesis method involving subjecting a gel precursor (where the particulates are formed) and/or another suspension/solution with a chemical reactant to a hydrothermal/solvothermal process. In this hybrid mode, the synthesis method may involve combining the concepts of a gel precursor (with formed particulates, as opposed to a chemical reactant) of U.S. Ser. No. 13/757,415 and the hydrothermal/solvothermal synthesis described herein.

The diameter and the length of the nanowires may depend on the reactant composition, the pH and concentration of the solution, the temperature, and the reaction time. In one embodiment, by fixing the reaction conditions but changing the reaction time, nanowire gels of different densities (and porosities) may be obtained.

The aerogels produced according to the methods described in some embodiments herein may have desirable properties, including high surface areas and high thermal resistivity. The material properties of the aerogels may depend on the material chemistry of the aerogel. The aerogel may be hydrophobic or hydrophilic. In one embodiment, a portion of the aerogel is hydrophilic and another portion thereof is hydrophobic. In one embodiment, the synthesis method may include disposing a coating comprising at least one hydrophobic surface over at least a portion of a surface of the aerogel. The disposing may involve any suitable surface treatment technique (e.g., vapor deposition). In one embodiment, the coating may cover at least substantially the entire surface of the porous aerogel. The aerogel may be elastic; in some embodiments, the aerogel exhibits superelasticity.

In one embodiment, the aerogels described herein may have a much higher electrical conductivity than an aerogel produced by a conventional technique. In another embodiment, the aerogels described herein may have a much lower electrical conductivity than an aerogel produced by a conventional technique. In some instances, the aerogels may be an insulator. In some other instances, the aerogels may be an electrical conductor. For example, the presently described aerogels may have an electrical conductivity that is larger than a conventional aerogel by a factor of at least about 2, about 3, about 4, about 6, about 8, about 10, or more. In some embodiments, the aerogel may have an electrical conductivity that is at least about 200 S/m—e.g., at least about 300, about 400 S/m, about 600 S/m, about 800 S/m; about 1,000 S/m; about 0.5×10⁴ S/m; about 1×10⁴ S/m; about 0.5×10⁵ S/m; about 1×10⁵ S/m; about 0.5×10⁶ S/m; about 1× 10⁶ S/m; about 0.5×10⁷ S/m; about 1×10⁷ S/m, or more. In one embodiment, the aerogel has an electrical conductivity of at least 3×10⁶ S/m.

The aerogels produced according to the methods described in some embodiments herein may have a mesoporous microstructure, having high porosity and/or high surface area (i.e., low density). The mesoporous microstructure may be an interconnected mesoporous microstructure. The pores may have any geometries. In some embodiments, the pores may be cylindrical, slit-shaped, or any other shape, or a combination of any of these. For example, the aerogels may have pore sizes ranging from about 1 nm to about 10 cm—e.g., about 10 nm to about 1000 microns, about 100 nm to about 100 microns, about 1 micron to about 10 microns. The aerogel may have a surface area of at least about 5 m²/g—e.g., at least 10 m²/g, about 20 m²/g, about 50 m²/g, about 70 m²/g, about 80 m²/g, about 90 m²/g, about 100 m²/g, about 150 m²/g, about 200 m²/g, about 300 m²/g, about 400 m²/g, about 600 m²/g, about 1000 m²/g, about 1200 m²/g, or more. In one embodiment, the aerogel has a surface area of at least about 5.5 m²/g. Alternatively (and/or additionally), the aerogels may have a density that is lower than or equal to about 200 mg/cm³—e.g., lower than or equal to about 150 mg/cm³, about 120 mg/cm³, about 100 mg/cm³, about 80 mg/cm³, about 60 mg/cm³, about 40 mg/cm³, about 20 mg/cm³, about 10 mg/cm³, about 5 mg/cm³, about 4 mg/cm³, about 3 mg/cm³, about 2 mg/cm³, or less.

As described above, the properties of the aerogels may depend on the materials involved. The mechanical properties of the aerogels described herein may be affected by the density and the chemical composition of the aerogels. In one embodiment, the Young's modulus may be at least about 2 MPa—e.g., about 2.5 MPa, about 5 MPa, about 7.5 MPa, about 10 MPa, about 15 MPa, about 20 MPa, about 25 MPa, about 30 MPa, or more. In one embodiment, at a density of 16 mg/cm³, the aerogel may have a Young's modulus value of at least about 20 MPa—e.g., at least about 25 MPa, about 30 MPa, or more. In another embodiment, at a density of 4 mg/cm³, the aerogel may have a Young's modulus value of at least about 2 MPa—e.g., at least about 2.5 MPa, about 3 MPa, or more. In one embodiment, these values may be for a case where the particulates comprise a metal oxide, including manganese dioxide. In one embodiment, the particulates comprises titania and the Young's modulus of the aerogel comprising same may be at least about 10 kPa—e.g., at least about 50 kPa, about 80 kPa, 100 kPa, 120 kPa, or more.

In one embodiment, at a density of 16 mg/cm³, the aerogel may have a tensile strength of modulus value of at least about 0.5 MPa—e.g., at least about 0.8 MPa, about 1 MPa, about 1.1 MPa, about 1.2 MPa, or more. In one embodiment, at a density of 4 mg/cm³, the aerogel may have a tensile strength of modulus value of at least about 0.05 MPa—e.g., at least about 0.08 MPa, about 0.1 MPa, about 0.11 MPa, about 0.12 MPa, or more. In one embodiment, these values may be for a case where the particulates comprise a metal oxide, including manganese dioxide. In one embodiment, the particulates comprises titania and the tensile strength of the aerogel comprising same may be at least about 1 kPa—e.g., at least about 5 kPa, about 8 kPa, 10 kPa, 10 kPa, or more.

In at least some embodiments, the aerogels described herein exhibit elastic mechanical behavior. In one example, the aerogels may exhibit superelastic behavior. In one embodiment, at a density of 4 mg/cm³, the aerogel may have a compressive strain as high as at least about 50% —e.g., at least about 60%, about 70%, about 80%, about 90%, about 95%, or more. In one embodiment, at a density of 16 mg/cm³, the aerogel may have a maximum compressive stress (at 90% strain) of at least about 0.02 MPa—e.g., at least about 0.03 MPa, about 0.035 MPa, about 0.04 MPa, or more. In one embodiment, these values may be for a case where the particulates comprise a metal oxide, including manganese dioxide.

As when the particulates contain silver, the aerogel may have (i) an electrical conductivity of at least about 3×10⁶ S/m, (ii) a density of less than or equal to about 90 mg/cm³, or both. Alternatively, when the particulates contain single-wall carbon nanotubes, the aerogels may have (i) an electrical conductivity of at least about 300 S/m, (ii) a density of less than or equal to about 2.7 mg/cm³, or both. Alternatively, when the particulates contain graphene, the aerogel may have (i) an electrical conductivity of at least about 400 S/m, (ii) a density of less than or equal to about 15 mg/cm³, or both.

Because of the aforedescribed desirable properties, aerogels described herein may be used in applications including catalysis, sensing, energy storage, solar cells, fuel cells, thermal insulation, ultra light structural media, and many other applications. For example, the aerogel may be a part of an electronic component (of an electronic device). In some embodiments, the electronic component may be a capacitor, including a super-capacitor.

### Contaminant Removal

Because of the aforedescribed desirable properties, aerogels described herein, including any of those made by any of the methods described above, may be used in applications to remove certain unwanted contaminants from a fluid. In one aspect, the aerogels may be employed in a method to remove unwanted contaminants from a fluid or to remove the fluid itself (e.g., in the case that the fluid is an oil or solvent and the aerogel is used as an absorbent therefor). The method may include: exposing a composition to a fluid comprising a component to be removed; and retaining a portion of the fluid in the composition such that at least some of the component in the fluid is retained in the composition.

The fluid may comprise any kind of fluid, including air, water, oil, or solvent. The water may be obtained from any source, such as lake, river, stream, ocean, and tap water. In one embodiment, the fluid itself is to be removed by being retained in a composition comprising the aerogel—e.g., in the case that the fluid is a solvent. In another embodiment, the fluid contains an unwanted contaminant component that is to be removed by being retained in a composition comprising the aerogel—e.g., in the case that the fluid is water. The (unwanted) component to be removed may comprise at least one of oil, solvent, metal-containing ions, microbes, microorganisms and an organic compound. Other types of unwanted components, including oil, smog, an organic compound, air-borne microbes and/or a microorganism, are also possible. The oil may comprise industrial oil, motor oil, engine oils, gasoline, etc. The solvent may comprise organic solvent, such as hexane, toluene, ethylene glycol, chloroform, cyclohexane, 1,2-dichlororbenzene, petroleum ether, kerosene, ethanol, etc. The metal-containing ions may comprise heavy metal ions, including, for example, Pb²⁺, Cd²⁺, Hg²⁺, Cr₂O₇²⁻, Cu²⁺, AsO₄³⁻ Fe²⁺, zn²⁺, Ni²⁺, cr²⁺, co²⁺, Al³⁺, etc.

In one embodiment, the fluid may comprise water, and the component comprises at least one of oil, solvent, metal-containing ions, microbes, microorganisms and an organic compound. In another embodiment, the fluid comprises air, and the component comprises at least one of oil, smog, an organic compound, air-borne microbes and a microorganism. The process of retaining, and thus removing, may involve any suitable method of physically or chemically retaining the unwanted contaminant from the fluid thus separating the two. In one embodiment, the retaining may comprise at least one of absorption, ion-exchanging reaction, redox and photo-catalytic redox reaction

In one embodiment, the aerogel may have a high weight-to-weight absorption capacity (W). “W” in one embodiment is defined as the ratio of the final weight after absorption to the initial weight before absorption. In one embodiment wherein the fluid is oil, the W of the aerogels described herein may be at least about 100—e.g., at least about 150, about 200, about 250, about 300, about 350, about 400, about 450, about 500, about 550, about 600, or higher.

The aerogel-containing composition described herein may be effective in removing contaminants from a fluid. For example, the removal efficiency of the unwanted contaminant component may be at least 40%—e.g., at least 50%, 60%, 60%, 70%, 80%, 90%, 95%, 99%, or higher.

Accordingly, the composition containing the aerogels described herein may be used in an article or device that is at least one of a solvent absorbent material and a water purification filter. Other applications may be possible. The aerogels may be used in spill clean ups and other environmental applications. Some other applications may include tap water filtration—e.g., to sterilize, remove organic molecules and metal ions. Another application may include a point-of-use filtration device—e.g., to obtain drinking water from most natural sources. Another application may include municipal water processing/sterilization. Another application may include waste water processing—e.g., to remove oil, heavy metal ions, kill microbes, etc. Another application may include air filtration, including indoor/in-vehicle air filtration—e.g., to kill airborne virus and bacteria, remove CO, NO, NO2 and other poisonous gases, etc. Another application may include portable air filtration—e.g., a facial mask or gas mask.

### NON-LIMITING WORKING EXAMPLES

### Example 1

Presented in this Example is a methodology to enable highly porous inorganic nanowire hydrogel/aerogel production for large scale and low cost. The hydrogels/aerogels were obtained from in-situ hydrothermal synthesis of one-dimensional (1D) nanowires which directly form a cross-linking network during the synthesis process. The resulting nanowires aerogels possess high porosity, high surface area, extremely low densities (can be as low as 2.9 mg/cm³) and were mechanically robust, and can have superelasticity by tuning the synthesis conditions. Their effective utilizations as water filters and absorbents to remove pollutants such as heavy metal ions, toxic solvents, and oil in water were also investigated. Results indicate these nanowire hydrogels/aerogels may be in environment applications such as water treatment based on a combination of the advantages of the nanowires' chemical properties (i.e., photo-catalytic, redox capability) and their nanometer structures as molecular-sieve, and the macro physical and mechanical character of 3-dimensional porous structures.

### Methods

Cryptomelane Manganese Oxide (K₂₋xMn₈O₁₆) Nanowire Hydrogel/Aerogels Production

The starting materials were composed of 19.1 mmol of potassium sulphate (K₂SO₄), potassium persulphate (K₂S₂O₈) and manganese sulphate monohydrate (MnSO₄.H₂O) in a ratio of 1:2:1 in 5 ml DI water. The precursor suspension was initially dispersed by ultra-sonication at room temperature, and filtration and dilution to avoid undissolved precipitates (A: non-treated, B: filtration of A with 0.8 μm syringe filter; C: two-fold dilutions of B; D: three-fold dilutions of suspension filtered with 0.2 μm syringe filter). The suspensions were transferred to a Teflon vessel and the sealed vessel was heated in an oven at 523 K for 10 min to 96 h of reaction time. The in-situ cryptomelane manganese oxide (K₂₋xMn₈O₁₆) nanowire hydrogels were washed with excess DI water and were cut into various shapes with a blade and then were placed into anhydrous ethanol overnight for solvent exchange. After that, the in-situ nanowire hydrogels were supercritically dried into aerogels to retain the original gel volume.

H₂Ti₈O₁₇ Nanowire Hydrogels/TiO₂ Nanowire Aerogels Production

Commercially available P25 was dissolved in 10 M KOH and NaOH solution and the concentration of P25 was 7.5 mgmL⁻¹. The mixture was stirred for 30 min and transferred to a Teflon vessel held in a stainless steel vessel. The sealed vessels were placed in an oven and heated at 453 K or 523 K for 4 h to 96 h, respectively. K₂Ti₈O₁₇ or Na₂Ti₈O₁₇ nanowire hydrogels were synthesized by a simple hydrothermal reaction of TiO₂ particles and KOH or NaOH solution and then ion-exchanged into H₂Ti₈O₁₇ by acid treatment (0.2 M HNO₃). After that, the hydrogels were washed with excess DI water without stirring or filtering to keep the gel networks intact and then cut into various shapes with a blade and subsequently placed into anhydrous ethanol overnight for solvent exchange. After that, the in-situ H₂Ti₈O₁₇ nanowire hydrogels were supercritically dried into aerogels to retain the original gel volume. Finally, H₂Ti₈O₁₇ nanowire hydrogels were transformed into anatase TiO₂ nanowire aerogels by calcination at 600° C. for 4 h.

Oil/Solvent Absorption Capacity Measurements

The cryptomelane nanowire aerogels were placed together with a polydimethysiloxane (PDMS) film in a covered glass container and heated at 234° C. for 2 h. Upon heat treatment, volatile silicone molecules in the form of short PDMS chains form a conformal layer on the metal oxide substrate and subsequently crosslink, to result in the formation of a silicone coating. The coated nanowire aerogel becomes almost superhydrophobic, as evidenced by a contact angle of 148° with a 13.3 μl water droplet. The weight-to-weight absorption capacities, W (wt/wt), were obtained by the ratio of the final mass of the nanowire aerogel after oil/solvent absorption to the initial mass before absorption.

Water Filter Measurements

The cryptomelane nanowire hydrogels were put into and sealed in syringe filter holders with 25 mm in diameter, and then MB or heavy metal ions filled in syringes were filtered through the nanowire hydrogel filters. The uptake capabilities of heavy metals were obtained by the ratio of removed metal ion amount to absorbent amount at removal 80%. For the absorption test using different absorbent dosages of cryptomelane nanowire hydrogels, the uptake capabilities were calculated from the slope of the curve for different absorbent dosages vs the removal %.

Characterization

Scanning electron microscopy (JEOL 6700F) was used to determine morphology and the porosities of the aerogel networks. High-magnification transmission electron microscopy (HRTEM, JEOL 2010) was measured to investigate the diameters and structures of cryptomelane and TiO₂ nanowires. X-ray diffraction (Rigaku RU300, CuKa radiation) analyzes the crystallinities of both nanowires. Nitrogen adsorption and desorption isotherms for porosities of the aerogels were measured at 77 K on a Micromeritics ASAP 2010 system. Before measurement, the samples were degassed at 423 K under vacuum (<10⁻⁴ mbar) for several hours. Surface areas of the aerogels were computed with Brunauer-Ennett-Teller (BET) method based on the multimolecular layer adsorption model.

Contact angle measurements were performed using a Rame-Hart model 590 goniometer after vertically dispensing droplets of deionized water on the silicon coated cryptomelane nanowire aerogel. TA instruments DMA model Q800 and MTS Nano Instruments Nano-UTM were used for tensile and compression tests of the cryptomelane nanowire aerogels, respectively. UV-vis spectra of methyl violet aqueous solution before/after filtration with the cryptomelane nanowire hydrogels were obtained by using a Varian Cary 6000i instrument. Inductively coupled plasma atomic emission spectroscopy (ICP-AES; ACTIVA-S, Horiba Jobin Yvon) was used to measure concentration of heavy metal ion after filtration.

Results

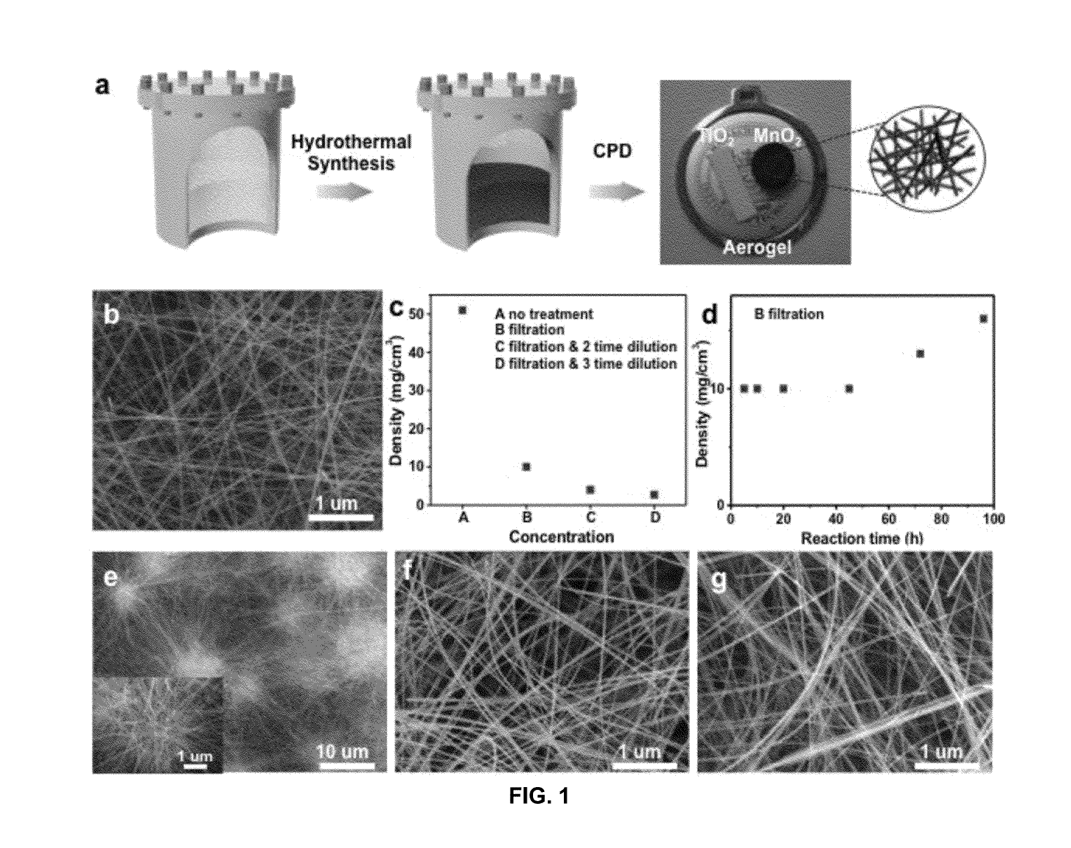

For the ultralight and highly porous hydrogel/aerogel structures, the method was designed to assemble nanowires into a highly porous interconnected nanowire network via controlling the hydrothermal synthesis conditions. FIG. 1(a) shows the inorganic nanowire hydrogel/aerogel production process: (i) the preparation of a well-dispersed precursor suspension, (ii) the in-situ nanowire hydrogel formation via hydrothermal synthesis, and (iii) the supercritical drying of the gel to form an aerogel. In this example, it was found that there are two important parameters needed to obtain the highly porous and ultralight nanowire hydrogels/aerogels in our method: first is the homogeneous precursor suspension at the proper precursor concentration to prevent non-uniformly bundling or aggregation of nanowires. Second is the proper reaction time to get the ultralong nanowire network without nanowire agglomeration, which result in high surface and remarkable mechanical properties for the networks as will be shown in the following.

Cryptomelane manganese oxide (K₂₋xMn₈O₁₆) nanowire hydrogels/aerogels were produced with 20 nm diameter. First of all, since formation of uniform and monodispersed nanostructures need precise control over the nucleation and growth processes, the uniform K₂-xMn₈O₁₆ reactant suspension (MnSO₄, K₂SO₄ and K₂S₂O₈) was initially prepared by ultra-sonication at room temperature, and filtered with syringe filter to remove un-dissolved precipitates caused by low solubility of potassium persulfate. After that, the suspension was transferred to a Teflon vessel and the sealed vessel was heated in an oven at 525 K for 10 min to 96 h of reaction time. At the beginning of the reaction, K₂₋xMn₈O₁₆ nanoparticles form by oxidation of manganese sulfate with an excess amount of potassium persulfate and K₂₋xMn₈O₁₆ nucleation develops from initial nanoparticle colloids and then cryptomelane manganese oxide nanowires start to grow at the expense of the colloids and continuously grow until all the colloids are consumed. As a result, the nanowires were self-assembled into an interconnected nanowire 3D network and the nanowire hydrogel formed after the reaction time of 5 h. The in-situ nanowire hydrogel networks formed at different reaction times were washed with excess DI water several times and subsequently the resultant hydrogels were supercritically dried into aerogels to retain the original gel volume.

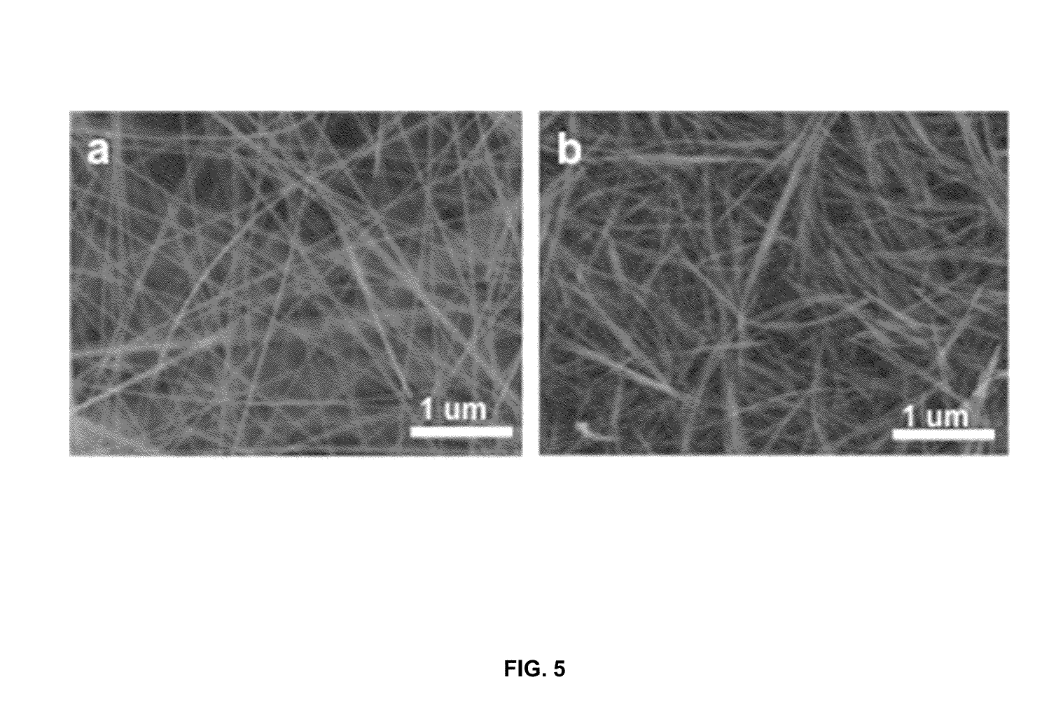

For ultrafine and highly porous in-situ 3D networks, the porosity of aerogel was tuned via variation of the initial concentration of the chemical reactant suspensions (A: reactant suspensions without any treatment; B: filtration of A with a 0.8 μm syringe filter; C: two-fold dilutions of B; D: three-fold dilutions of the suspension after filtration of A with a 0.2 μm syringe filter). The resultant aerogels obtained from B, C, and D (FIG. 1(f), 1(b), 5(a) show high porosity and high surface area (80 m²g⁻¹) due to ultrafine nanowire network without bundles, while the aerogel obtained from A shows low porosity caused by aggregated nanowire network (FIG. 5b). As the concentration decreases via dilution and filtration, the porosity increases and the density decreases. Especially, the aerogel from D has a very low density of 2.9 mg/cm³, which is 17 times lower than one of previously reported MnO₂ nanowire block and only slightly higher than an air density of 1.2 mg/cm³. It was observed that the nanowire gel formation concentration depends on the aspect ratio of the nanowires. Because the in-situ nanowire gel was obtained directly from hydrothermal synthesis without the dispersion of the nanowires, ultralong nanowires with a length up to several hundred micrometers remained in the gel network, giving rise to very high aspect ratio. As the result, the in-situ gel could form at much lower concentration and the resulting aerogel has very low density.

FIGS. 1(e)-1(g) are the SEM images of the cryptomelane manganese oxide nanowire aerogels from in-situ gels obtained at the reaction times of 5, 45, and 96 h, respectively, where highly porous nanowire network with pore sizes in the range of a few hundred nanometers to a few micrometers are observed. The concentration B was chosen to observe the change of the network and density as a function of the reaction time. At the beginning of the reaction, small islands of nanowires were observed in the suspension, but no hydrogels was formed. As time went on, the islands became bigger and started to interlink with each other, and hydrogels formed with the same volume as the starting suspension. FIG. 1(e) shows the SEM of the resulting aerogel obtained with a reaction time of 5 h, where a chestnut-bur-like nanowire network can be seen. On the other hand, longer reaction time of 45 h and 96 h show cross-aligned ultra-long nanowire network (FIGS. 1(f) and 1(g), respectively). Surprisingly, the densities of the nanowire networks obtained from a reaction time between 5 h and 45 h gave a constant value of 10 mg/cm³ (FIG. 1(d), their hydrogels have the same volume after the reaction). Not to be bound by any theory, but this suggests that between 5 h and 45 h, rearrangement of the nanowires within the network occurred. When the reaction time was longer than 45 h, the volume of the hydrogel (and the resulting aerogel) shrank, giving rise to an increase in density (FIG. 1(d)). This can be seen in the SEM of FIG. 1(g), at an excessive reaction time of 96 h, here some nanowire bundles in the network can be observed. Not to be bound by any theory, but this is, possibly due to the van der Waals forces between the nanowires, resulting in a network with decreased porosity and increased density (16 mg/cm³) and 45% shrunk in volume (FIG. 1(d)).

Similarly, highly porous and lightweight TiO₂ nanowire aerogels with either 10-15 nm diameter or 50-60 nm diameter were produced. See Example 2. This method enables highly porous and ultralight inorganic nanotube/nanowire hydrogels/aerogels with various inorganic materials.

Characterization of Mechanical Properties

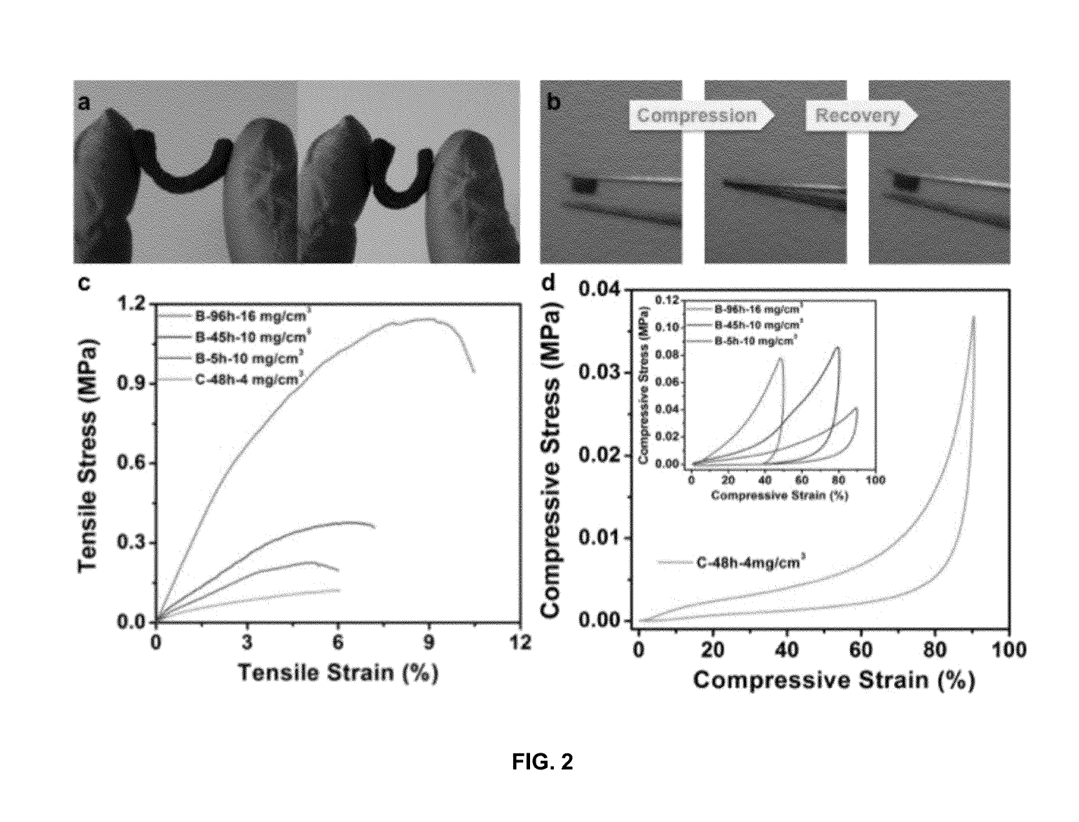

For the applicability as oil/solvent absorbents, the mechanical properties of the resultant cryptomelane nanowire aerogels were characterized in different densities of 16 (for 96 h at concentration B), 10 (5 h or 45 h at B), and 4 mg/cm³ (48 h at C). For this, surface treatment was performed to obtain hydrophobic surfaces using a vapor deposition technique that provided a coating over the entire surface of the porous material. In FIGS. 2(a) and (b), the cryptomelane nanowire aerogels show robust, flexible, bendable and super-elastic properties.

For the tension test, the Young's modulus (E) of the 10 mg/cm³ aerogel with chestnut-like nanowire network at a short reaction time of 5 h was found to be lower than one of aerogel with ultralong nanowire network at a long reaction time of 45 h (FIG. 2(c)). From this result, the ultralong nanowire network was found to play an important role in improvement of the tensile property of highly porous inorganic nanowire network by our method. The ultralong nanowire aerogel with the highest density of 16 mg/cm³ shows the highest E of 25.7 MPa and tensile strength of 1.14 MPa, which shows the increase in Young's modulus (E) with increasing density. Surprisingly, the aerogel with very low density of 4 mg/cm³ has even high E of 2.5 MPa, which is much higher than the E of 0.28 Pa for MnO₂ nanowire block with 12.5 times higher density of 50 mg/cm³ and also is the highest value compared to those of other material aerogels at the low density. From these results, it was found that the uniform isotropic network composed of ultralong nanowires obtained by tuning the concentration and reaction times contributes to the excellent mechanical properties even though the network has high porosity and low density.

In the case of the compression test, these nanowire aerogels with 4, 10, and 16 mg/cm³ show elastic mechanical behavior (FIG. 2(d). Surprisingly, the aerogel with low density of 4 mg/cm³ was found to bear a compressive strain (ε) as high as 90% and also show superelastic behavior that was able to completely recover its original shape when released from compression (FIG. 2(d). The maximum compressive stress of the aerogel is 0.038 MPa (at ε=90%) which is much higher than those of carbon-based foams with a similar density. The desirable mechanical property of the 4 mg/cm³ aerogel results from extremely low density and highly porosity by tuning concentration and reaction times. These superior mechanical properties, such as high Young's modulus, strong tensile strength, and elasticity, serve as an important advantage for our nanowire aerogels as desirable absorbents in many applications.

Oil/Solvent Absorbent Material Application.

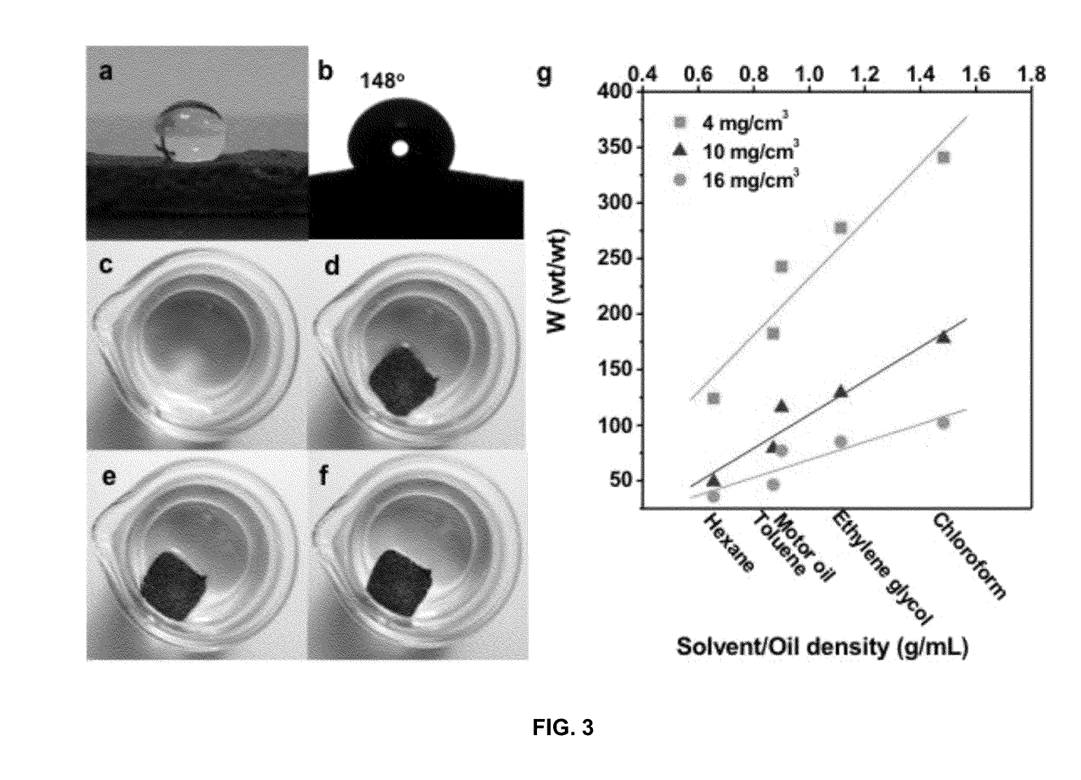

The resultant cryptomelane nanowire aerogels were used to remove oil and toxic organic solvents in water (FIG. 3(g). It was observed that for the process of motor oil absorption of 10 mg/cm³ cryptomelane nanowire aerogel (FIG. 3(c)-3(f)), and the aerogel absorbed selectively and quickly the motor oil (stained with Oil blue 35) floating on DI water within 41 s. FIG. 3(g) shows the absorption capacities (defined by W (wt/wt), the ratio of the final weight after absorption to the initial weight before absorption) for the motor oil and solvents with the aerogels having densities of 4, 10 (45 h), and 16 mg/cm³.

The aerogel with lower density was found to exhibit better absorption performance having a higher slope for solvent/oil density. The aerogels with a low density of 4 mg/cm³ achieved up to W=250 for motor oil—this is 7.5 times higher than that of conventional absorbents (i.e., W=36 for Woolspill™ knops with a density of 33 mg/cm³). Furthermore, these aerogels achieved as high as W=350 for chloroform, which is the highest value compared with those of previously reported absorbents due to their superior properties such as high porosity, high surface area, strong mechanical strength, and superelasticity. Therefore, the highly efficient in-situ synthetic cryptomelane nanowire aerogel by described in this Example is a suitable candidate as oil/solvent absorbent for environmental applications on a global scale regarding the increased risk in oil spill catastrophes.

Water Purification Filter Application

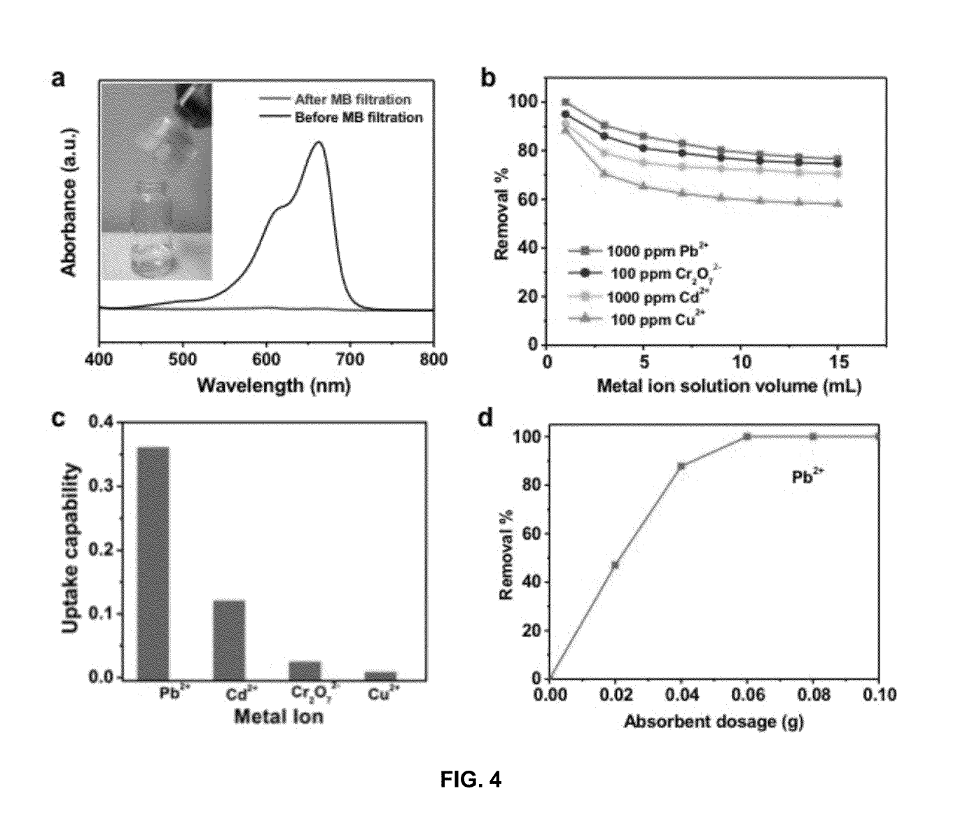

The in-situ cryptomelane nanowire hydrogels could be used as water purification filters for the removal of toxic pollutants, including organic dyes and heavy metal ions since one of the unique advantages of our method is to enable the in-situ porous inorganic nanowire hydrogel production with high scalability and without critical point drying. Firstly, filtration of methylene blue (MB) was performed with the cryptomelane nanowire hydrogel filter inserted in a syringe holder as shown in FIG. 4(a). It was confirmed that the MB were removed completely via UV-vis-spectrum (FIG. 4(a)) after filtration of 0.1 wt % MB. The porous nanowire hydrogels are an excellent filter for organic dyes due to high surface area and the electrostatic forces between the filter and dye.

Further, the performance of the nanowire hydrogels as water filters for the removal of heavy metal ions was investigated for: 1000 ppm Pb²⁺, 1000 ppm Cd²⁺, 100 ppm Cr₂O₇²⁻, or 100 ppm Cu²⁺. The nanowire hydrogel filters exhibited efficient performance in removing the metal ions, which had the highest uptake of Pb²⁺, Cd²⁺, Cr₂O₇²⁻, or Cu²⁺ is 100, 91, 95, or 88.3% and were saturated at 78, 70, 75, 59%, respectively (FIG. 4(b)). The uptake capability via filtration (defined as the ratio of removed metal ion amount to absorbent amount at removal 80%) was determined to be Pb²⁺>Cd²⁺>Cr₂O₇²⁻>Cu²⁺, and especially, the uptake capability 0.36 g/g of Pb²⁺ ions showed selectively higher efficiency than other metal ions due to the negative surface charge and the inherent tunnel structures of manganese oxide.

Also in FIG. 4(d), the absorption test using different absorbent dosages of 0.02, 0.04, 0.06, 0.08, and 0.1 g cryptomelane nanowire hydrogels show high removal % of 47, 87.8, 100, 100, and 100%, respectively. The uptake capability for the absorption (calculated from the slope of FIG. 4(d)) is 0.6 g/g. As a result, it can be concluded that the cryptomelane nanowire hydrogel filters can be used in the removal of heavy metal ion, especially lead ions from industrial wastewaters.

In sum, presented in this Example is a methodology to enable ultralight and highly porous inorganic nanowire hydrogels/aerogels production from in-situ nanowire networks composed of interconnected inorganic nanowires obtained by hydrothermal synthesis without supporting materials by controlling the initial concentration and reaction time. The superior properties, such as high porosity and high surface, are demonstrated using absorbents or water filters able to efficiently remove the pollutants such as oil, toxic solvents, and heavy metal ions in water, which are much higher than those of conventional ones.

### Example 2

### S1. Cryptomelane Manganese Oxide (K₂₋xMn₈O₁₆) Nanowire Hydrogel/Aerogels

Very porous and low density of 2.9 mg/cm³ cryptomelane nanowire aerogels (FIG. 5(a)) were obtained from D suspension (three-fold dilutions of suspension filtered with 0.2 μm syringe filter) at 48 h. In contrast, the nanowire network from the non-treated suspension A with the same reaction time of 48 h results in a much lower porosity and high density of 51 mg/cm³ sample (FIG. 5(b)).

### S2. H₂Ti₈O₁₇ Nanowire Hydrogels/TiO₂ Nanowire Aerogels

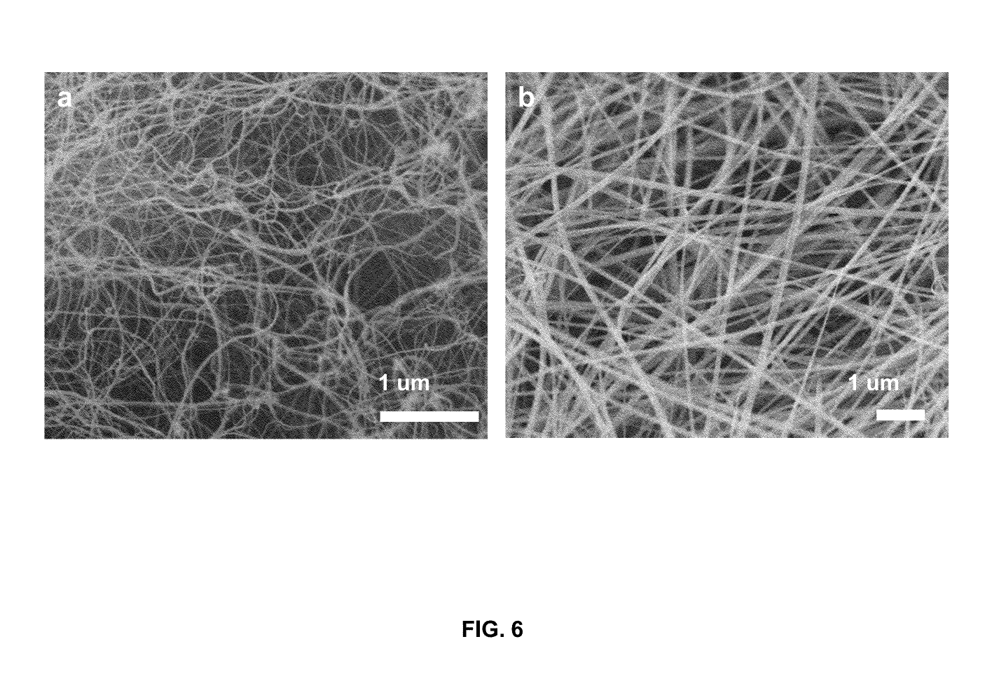

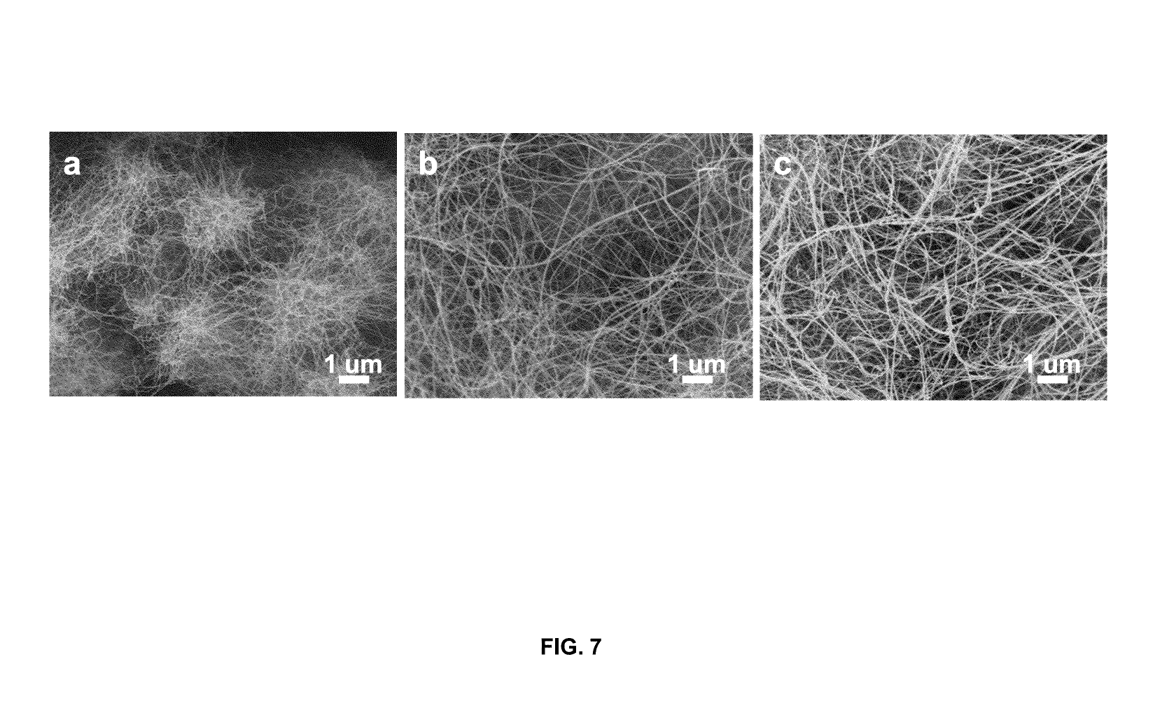

Highly porous and lightweight TiO₂ nanowire aerogels have 10-15 nm or 50-60 nm diameter nanowires network obtained from KOH or NaOH, respectively (FIG. 6). In the case of smaller diameter TiO₂ nanowire aerogels, the porosity is tuned by different reaction times of 4, 16, and 48 h (FIGS. 7(a), (b)). The TiO₂ nanowire aerogel from a short reaction time of 4 h shows chestnut bur-like nanowire network (FIG. 7(a)), as time passed by 16 h, the aerogel is rearranged into cross-aligned nanowire network with low density (16 mg/cm³), high porosity, and very high surface area (292 m²g⁻¹). From this result, it was confirmed that the synthesis mechanism of H₂Ti₈O₁₇ nanowire hydrogels is the same as K₂₋xMn₈O₁₆ nanowire hydrogels.

Therefore, this method enables highly porous and ultralight inorganic nanotube/nanowire aerogels with various inorganic materials.

### S3. The Characterization of Structures of the Cryptomelane Manganese Oxide (K₂₋xMn₈O₁₆)₅ and TiO₂ Nanowire Aerogels

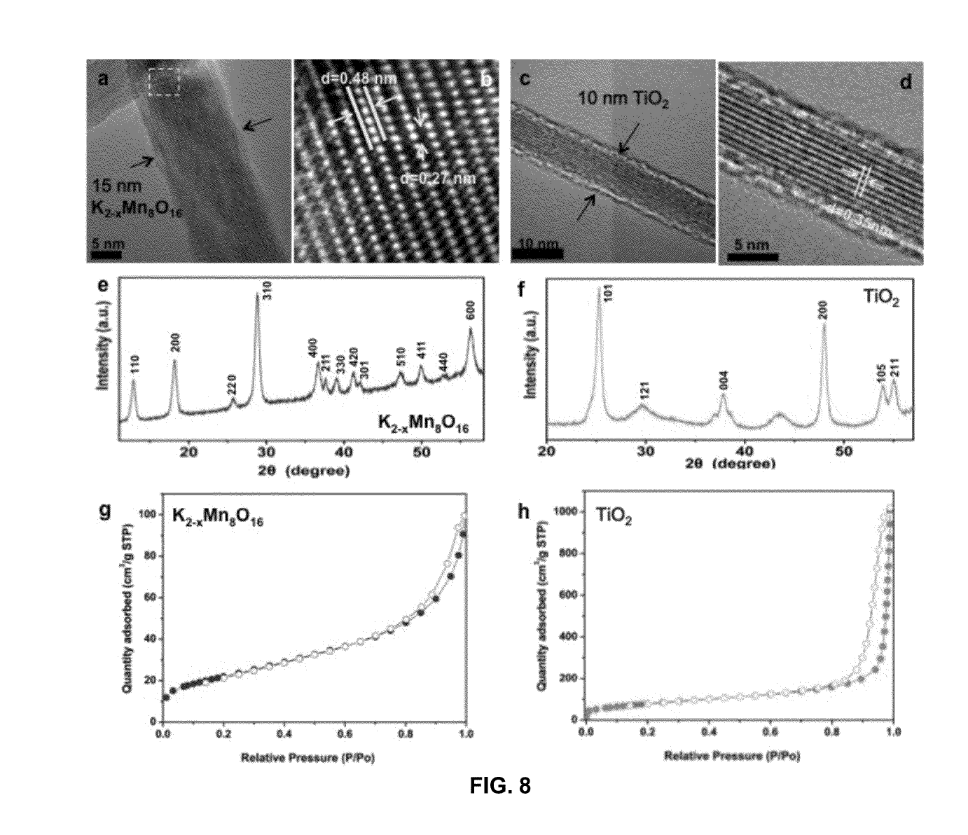

To identify the crystallinity of fabricated nanowires in networks, the structure of both nanowire aerogels was investigated by high-magnification transmission electron microscopy (HRTEM) and X-ray diffraction (XRD) analyses in FIG. 8. The HRTEM image of the nanowire shown in FIG. 8(b) reveals lattice fringes of the {002} and {011} with a d-spacing of 0.48 nm and 0.27 nm, respectively, typical for monoclinic K₂₋xMn₈O₁₆. Within this nanowire, the [001] crystallographic direction is essentially parallel to the long axis direction of the nanowire. The XRD pattern (FIG. 8(e)) of the nanowire can be indexed in accordance with the [100] zone axis of a cryptomelane-M type (K₂₋xMn₈O₁₆) crystal (Joint Committee on Powder Diffraction Standards file no. 44-1386: a=9.942 Å, b=2.866 Å, c=9.709 Å).

In FIG. 8(d), the magnified HRTEM image of the TiO₂ nanowire exhibits high crystalline structure with a d-spacing of 0.35 nm, corresponding to the spacing of (1 0 1) planes of anatase TiO₂ phase. The peak positions of the XRD pattern (FIG. 8(f)) are well indexed in accord with anatase TiO₂ with crystalline cell constants a=3.7806 Å, c=9.4977 Å, which are basically in agreement with the reported values (JCPDS No. 21-1272). Although the diffraction peak of Brookite (denoted as concentration B in FIG. 8(f)) can also be found, it is much lower than those of anatase phase. No characteristic peaks of other impurities were observed, which indicates that the product has high purity.

The porosities of cryptomelane and TiO₂ nanowire aerogels were confirmed by N₂ adsorption-desorption analysis. These aerogels showed a type IV isotherm with H3-type hysteresis loop, which indicates that mesopores have cylindrical pore geometries. The surface areas were calculated with the Brunauer-Ennett-Teller (BET) method. The ultra-fine porous cryptomelane and TiO₂ nanowire networks result in high surface areas of 80 m²g⁻¹ and 292 m²g⁻¹, respectively (FIGS. 8(g) and (h)), which are 2 times larger than the surface area of both nanowire membranes.

### Example 3

This Example explores the 3-dimensional network structure developed herein based on TiO₂ and MnO₂ nanowires, which uniquely combines the advantage of photo-catalysis, redox, ion-exchange, and the excellent mechanical properties, yet the production process is very economical and suitable for large scale industrial practice. Preliminary results show that such new materials have great potential to remove organic molecules, heavy metal ions and microbes effectively, therefore may offer a more advantageous alternative in the field of water treatment.

Aerogels are porous solid materials with ultra high surface area and low bulk densities and low thermal conductivities. As a result, they have a wide range of applications such as catalysis, sensing, energy storage, adsorption, thermal insulation, etc. For certain nanowire or nanotube or nanosheet materials which can be synthesized via hydrothermal method, their gels and aerogels can be fabricated at much lower cost. Furthermore, the aerogel surprisingly was used in applications for water treatment, which is beyond the typical application of aerogels.

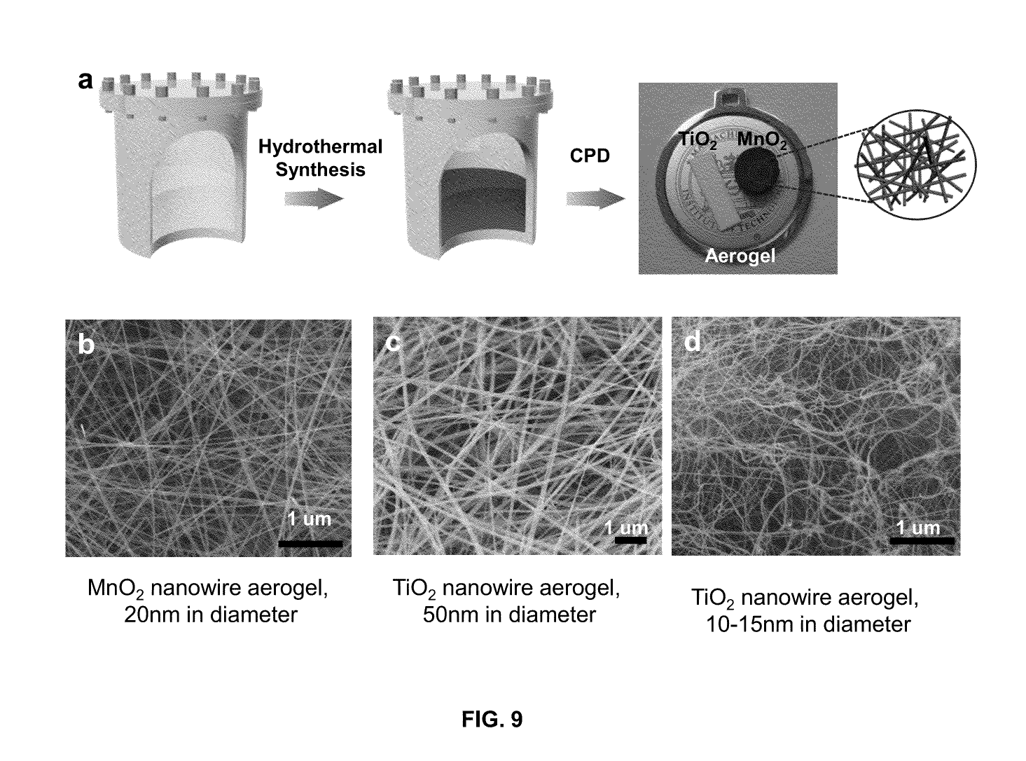

FIG. 9(a) shows a schematic diagram of how the aerogels of MnO₂ and TiO₂ nanowires are made. The nanowire gels form during the process of hydrothermal synthesis. By controlling the reactant concentration and time, aerogels with different densities can be achieved. In order to form aerogels from gels, critical point drying (CPD) is needed. However, for the water treatment application gels can be used directly, and thus the production process is only one step and is very economical. FIGS. 9(b)-9(d) show the morphology of the aerogels under scanning electron microscope. These images indicate highly porous nanowire networks with pore sizes in the range of a few hundred nanometers to a few micrometers, which suggest clogging most likely will not be an issue for these nanowire filters.

FIG. 4(a) shows that when passing methylene blue solution through the MnO₂ gel filter, clear water can be obtained. This is also shown on the absorbance result shown in FIG. 4(b). Preliminary results also show these MnO₂ gel filters effectively remove Cr ions with much higher ability than the active carbon (AC) filters (from color). With MnO₂ and TiO₂ nanowires, it has been either reported or predicted that a wide range of inorganic metal ions (Pb, Hg, Ag, Cu, As, etc.) can be removed, via ion exchange, adsorption, redox or photo-catalyzed redox mechanisms. Thus, it is anticipated that these nanowire gels will be much more effective than AC in water treatment to remove both organic compounds, inorganic ions and microbes.

Another advantage of these gel filters is their structures and desirable mechanical properties, resulting from the hydrothermal synthesis. In contrast to ACs, which come in either powdered or granular forms and are needed to be packed during manufacturing, these well-structured gels are monolithic and can be molded into any shape. FIG. 2 shows the tensile (a) and compressive (b) response of the MnO₂ aerogel (density 4 mg/cm³), with a tensile strength of ˜30 kPa, this value is even better than materials with 3D structure networks of much higher density. On the other hand, they are super-elastic: they can be compressed to <10% in volume and then restored completely. These tests have been repeated a thousand times without degradation.

The MnO₂ nanowires synthesized by pre-existing method were made into paper form and modified to be hydrophobic and to show its unique advantage in oil spill on water. However, the mechanical strength of the MnO₂ paper assembly was an issue and the market for oil spill clean-up is limited. With the gel structure presented herein both challenges were overcome. In this Example, these MnO₂ aerogels can also be modified to be superhydrophobic and the oil uptake can be 350 times its own weight (previous best result was 20 times with MnO₂).

### ADDITIONAL NOTES

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed:

1. A method of making, comprising:
(A) subjecting a suspension or a solution comprising a concentration of at least one chemical reactant to at least one of a hydrothermal and a solvothermal process for at least a reaction time to form an in-situ hydrogel, wherein the hydrogel comprises particulates having an asymmetric geometry; and
(B) removing a liquid from the hydrogel to form an aerogel.

2. The method of claim 1, wherein the formation of the in-situ hydrogel comprises a one step process.

3. The method of claim 1, wherein the in-situ hydrogel comprises a metal, an oxide, a nitride, a sulfide, a semiconductor, a carbon-containing material, or combinations thereof.

4. The method of claim 1, wherein the in-situ hydrogel comprises at least one of manganese dioxide, titanium oxide, zinc oxide, zirconium oxide, copper oxide, and chromium oxide.

5. The method of claim 1, further comprising controlling at least one of the reaction time and the concentration involved in the hydrothermal process to affect formation of the hydrogel

6. The method of claim 1, further comprising controlling the concentration such that the particulates in the in-situ hydrogel substantially do not aggregate.

7. The method of claim 1, further comprising controlling at least one of a temperature and a pressure involved in the hydrothermal process to affect formation of the hydrogel.

8. The method of claim 1, further comprising subjecting the suspension or the solution to at least one of sonication and filtering before (A).

9. The method of claim 1, wherein the particulates are in the form of a three-dimensional network.

10. The method of claim 1, wherein (B) is carried out by at least one of (i) freeze drying, (ii) supercritical point drying, and (iii) drying in an ambient condition.

11. A method of using, comprising:
(A) exposing a composition to a fluid comprising a component to be removed; and
(B) removing the component from the fluid by retaining a portion of the fluid in the composition such that at least some of the component in the fluid is retained in the composition;
wherein the composition comprises a hydrogel or an aerogel, which comprises particulates having an asymmetric geometry.

12. The method of claim 11, wherein the fluid comprises water, and the component comprises at least one of oil, solvent, metal-containing ions, microbes, microorganisms and an organic compound.

13. The method of claim 11, where the fluid comprises air, and the component comprises at least one of oil, smog, an organic compound, air-borne microbes and a microorganism.

14. The method of claim 11, wherein the retaining further comprises at least one of absorption, ion-exchanging reaction, redox and photo-catalytic redox reaction.

15. The method of claim 11, further comprising a method of making the composition, comprising: subjecting a concentration of a suspension or a solution comprising a concentration of at least one chemical reactant to at least one of a hydrothermal and solvothermal process for at least a reaction time to form an in-situ hydrogel, wherein the hydrogel comprises particulates having asymmetric geometry,

16. The method of claim 11, further comprising a method of making the composition, comprising: removing a liquid from the hydrogel to form an aerogel.

17. The method of claim 11, further comprising a method of making the composition, comprising: disposing a coating comprising at least one hydrophobic surface over at least a portion of a surface of the composition.

18. The method of claim 11, wherein the component comprises oil and the composition exhibits a weight-to-weight absorption capacity (W) of the component of at least about 250.

19. A composition, comprising:
an aerogel, which
comprises particulates having an aspect ratio of at least 50 and comprising at least one metal oxide; and
having a density of less than or equal to about 16 mg/cm³.

20. The composition of claim 19, wherein the particulates have a length that is greater than or equal to about 100 microns and a diameter that is less than or equal to about 500 nm.

21. The composition of claim 19, wherein the composition has a density of about 16 mg/cm³ and at least one of the following:
(i) a Young's modulus of at least 25 MPa; and
(ii) a tensile strength of at least about 1.1 MPa.

22. The composition of claim 19, wherein the composition has a density of about 4 mg/cm³ and at least one of the following:
(i) a Young's modulus of at least 2.5 MPa;
(ii) a tensile strength of at least about 0.1 MPa;
(iii) a compressive strain of at least about 90%;
(iv) a maximum compressive stress of 0.035 MPa; and
(v) a weight-to-weight absorption capacity (W) for an oil of at least about 250.

23. An article comprising the composition of claim 19, wherein the article is a part of at least one of a solvent absorbent material, air filtration material, and a water purification filter.
